(19) United States
(12) Patent Application Publication
(10) Pub. No.: US 2022/0200009 A1
(43) Pub. Date: Jun. 23, 2022

(54) SECONDARY BATTERY ELECTRODE

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/451,326

(22) Filed: Oct. 19, 2021

(30) Foreign Application Priority Data
Dec. 17, 2020 (JP) 2020-209477

(51) Int. Cl. H01M 4/66; H01M 50/116

(52) U.S. Cl. CPC H01M 4/661; H01M 4/666; H01M 50/116

(57) ABSTRACT

A secondary battery electrode includes: a current collector made of a porous metal material; and an electrode material mixture with which the current collector is filled. The current collector includes a material mixture-filled segment that is filled with the electrode material mixture, and a material mixture-unfilled segment that is unfilled with the electrode material mixture. The material mixture-unfilled segment includes a current-collecting tab which is thinner than the material mixture-filled segment and in which the porous metal material is present at a higher density than in the material mixture-filled segment, and a tab convergence portion via which the material mixture-filled segment is coupled to the current-collecting tab. The tab convergence portion is provided with at least one rib extending from a side adjacent to the material mixture-filled segment toward the current-collecting tab.

This application is based on and claims the benefit of priority from Japanese Patent Application No. 2020-209477, filed on 17 Dec. 2020, the content of which is incorporated herein by reference.

### BACKGROUND OF THE INVENTION

### Field of the Invention

The present disclosure relates to a secondary battery electrode.

### Related Art

A secondary battery electrode has been known which includes a current collector made of a porous metal material, and an electrode material mixture with which the current collector is filled. For example, Patent Document 1 discloses a technique of this type. The secondary battery electrode disclosed in Patent Document 1 includes a band-shaped porous material having a three-dimensional mesh structure and filled with an active material, and a current-collecting tab integrally disposed on a middle portion of the band-shaped porous material in a thickness direction. Using a porous metal material as a current collector as in Patent Document 1 can increase a filling density of an electrode active material.
Patent Document 1: Japanese Unexamined Patent Application, Publication No. 2002-279979

### SUMMARY OF THE INVENTION

Meanwhile, in some cases, a secondary battery electrode including a porous metal material configured as a current collector is produced by a process including forming a material mixture-filled segment in which pores of the current collector are filled with an electrode material mixture and a material mixture-unfilled segment in which pores of the current collector are not filled with the electrode material mixture, and then, subjecting the material mixture-unfilled segment to rolling whereby a current-collecting tab is formed. However, for example, when secondary battery electrodes of this type are stacked on each other or when the current-collecting tabs are put together and welded to a lead tab, a strong stress is likely to be applied to, for example, a boundary between the material mixture-filled segment and the material mixture-unfilled segment and a portion of the material mixture-unfilled segment corresponding to a boundary between an area where the current-collecting tab is formed and an area where the current-collecting tab is absent. The stress applied to these boundaries may cause cracks and rupture in the secondary battery electrode, thereby giving rise to the risk of a decrease in output and a decrease in durability of the battery. It is conceivable to gently curve the boundaries (to round the boundaries) to reduce the stress applied to the boundaries. However, such curving leads to an increase in the length of the current-collecting tab and may reduce the energy density of the secondary battery electrode.

The present disclosure is intended to provide a secondary battery electrode that includes a porous metal material configured as a current collector, and has an improved durability and an increased energy density.

An aspect of the present disclosure is directed to a secondary battery electrode including: a current collector made of a porous metal material; and an electrode material mixture with which the current collector is filled. The current collector includes a material mixture-filled segment that is filled with the electrode material mixture, and a material mixture-unfilled segment that is unfilled with the electrode material mixture. The material mixture-unfilled segment includes a current-collecting tab which is thinner than the material mixture-filled segment and in which the porous metal material is present at a higher density than in the material mixture-filled segment, and a tab convergence portion via which the material mixture-filled segment is coupled to the current-collecting tab. The tab convergence portion is provided with at least one rib extending from a side adjacent to the material mixture-filled segment toward the current-collecting tab.

The at least one rib may be formed by way of pressing the porous metal material.

The current-collecting tab may have a stress alleviation portion constituted by ridges and grooves that extend in a width direction of the current-collecting tab, and the ridges and grooves may have a rectangular or square wave shape, a sine wave shape, a triangular wave shape, or a sawtooth shape as viewed in cross section.

The tab convergence portion may be filled with a reinforcing material that reinforces the tab convergence portion.

The tab convergence portion may be covered with the reinforcing material with which the tab convergence portion is filled.

The reinforcing material may be electrically insulating.

The reinforcing material may be thermally conductive.

The tab convergence portion may have a rib-formed portion where the rib is formed, and a slanting portion which slant such that a thickness thereof decreases in a direction from the material mixture-filled segment to the current-collecting tab. The tab convergence portion may be provided with cushioning members disposed at least on surfaces of the slanting portion, the surfaces being opposite in a thickness direction of the slanting portion. The cushioning members may also be disposed on the rib-formed portion.

The present disclosure provides a secondary battery electrode that includes a porous metal material configured as a current collector, and has an improved durability and an increased energy density.

### BRIEF DESCRIPTION OF THE DRAWINGS

FIG. 1 is a planar view illustrating a secondary battery electrode according to a first embodiment of the present disclosure;

FIG. 2 is a cross-sectional view taken along line A-A in FIG. 1;

FIG. 3 is a planar view illustrating a secondary battery electrode according to a second embodiment of the present disclosure; and

FIG. 4 is a cross-sectional view taken along line B-B in FIG. 3.

### DETAILED DESCRIPTION OF THE INVENTION

Embodiments of the present disclosure will be described with reference to the drawings. Note that the following embodiments are non-limiting examples of the present disclosure, and are not intended to limit the scope of the present disclosure.

### First Embodiment

<Electrode>

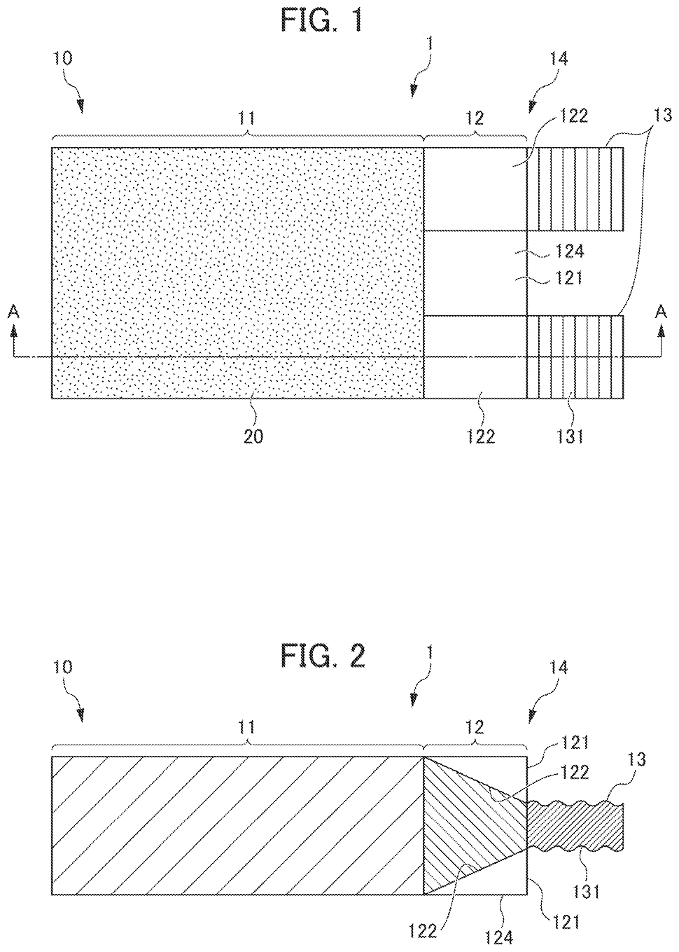

A secondary battery electrode 1 of the present embodiment will be described with reference to FIGS. 1 and 2. FIG. 1 is a planar view illustrating the secondary battery electrode 1. FIG. 2 is a cross-sectional view of the secondary battery electrode 1, taken along line A-A in FIG. 1. Note that an electrode material mixture 20 included in the secondary battery electrode 1 is not illustrated in FIG. 2. As illustrated in FIG. 1, the secondary battery electrode 1 includes a current collector 10 made of a porous metal material, and the electrode material mixture 20 with which the current collector 10 is filled.

[Electrode Material Mixture]

The electrode material mixture 20, with which the current collector 10 is filled, includes at least an electrode active material. The electrode material mixture 20 applicable to the present embodiment only needs to include the electrode active material as an essential component, and may optionally include additional components. The additional components are not limited to any particular components. Examples of the additional components include, but are not limited to, a solid electrolyte, a conductive agent, and a binder.

The electrode material mixture 20 to form part of a positive electrode needs to include at least a positive electrode active material, and may include, as additional components, a solid electrolyte, a conductive agent, a binder, etc. The positive electrode active material may be any material as long as it can absorb and desorb lithium ions. Examples of the positive electrode active material include, but are not limited to, LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur.

The electrode material mixture 20 to form part of a negative electrode needs to include at least a negative electrode active material, and may include, as additional components, a solid electrolyte, a conductive agent, a binder, etc. The negative electrode active material may be any material as long as it can absorb and desorb lithium ions. Examples of the negative electrode active material include, but are not limited to, metallic lithium, lithium alloys, metal oxides, metal sulfides, metal nitrides, Si, SiO, and carbon materials such as artificial graphite, natural graphite, hard carbon, and soft carbon.

[Current Collector]

The current collector 10 is made of the porous metal material. The porous metal material has pores that are continuous with each other. The interiors of the pores can be filled with the electrode material mixture 20 including the electrode active material. The porous metal material may be any material having pores continuous with each other. Examples of the porous metal material include, but are not limited to, a metal foam having pores produced due to foaming, a metal mesh, an expanded metal, a perforated metal, and an unwoven metal fabric. Any metal may be used as the porous metal material, as long as it has an electrical conductivity. Examples of the metal include, but are not limited to, nickel, aluminum, stainless steel, titanium, copper, and silver. Among them, an aluminum foam, a nickel foam, and a stainless-steel foam are preferred as the material for the current collector 10 forming part of a positive electrode, whereas a copper foam and a stainless-steel foam are preferred as the material for the current collector 10 forming part of a negative electrode.

The current collector 10 made of the porous metal material has therein the pores and is larger in surface area than a conventional current collector 10 made of a metal foil. When the porous metal material described above is used as the current collector 10, the pores can be filled with the electrode material mixture 20 including the electrode active material. Due to this configuration, an amount of the active material per unit area of an electrode layer can be increased. As a result, the secondary battery can have an improved volumetric energy density. Further, fixation of the electrode material mixture 20 is facilitated. Therefore, unlike the conventional electrode including a metal foil as a current collector, it is unnecessary to thicken a coating slurry for use to form a thick layer including electrode material mixture layers stacked together. As a result, an amount of a binder such as an organic polymer composition that has conventionally been needed for the thickening can be reduced. Thus, a capacity per unit area of the secondary battery electrode 1 can be increased, thereby making it possible to achieve a large-capacity battery.

Next, the configuration of the current collector 10 according to the present embodiment will be described in detail. As illustrated in FIGS. 1 and 2, the current collector 10 has a horizontally-orientated plate shape, and includes a material mixture-filled segment 11 and a material mixture-unfilled segment 14.

(Material Mixture-Filled Segment)

The material mixture-filled segment 11 is a region forming part of the current collector 10 and filled with the electrode material mixture 20. The material mixture-filled segment 11 extends from one end of the current collector 10 (the end shown on a left side in FIGS. 1 and 2) to a vicinity of the middle of the current collector 10.

(Material Mixture-Unfilled Segment)

The material mixture-unfilled segment 14 is a region forming part of the current collector 10 and not filled with the electrode material mixture 20. The material mixture-unfilled segment 14 includes current-collecting tabs 13 and a tab convergence portion 12 via which the material mixture-filled segment 11 is coupled to the current-collecting tabs 13.

The tab convergence portion 12 resides between the material mixture-filled segment 11 and the current-collecting tabs 13 constituting the other end of the current collector 10 (the end shown on a right side in the FIGS. 1 and 2). The tab convergence portion 12 is formed by leaving a corresponding portion of the current collector 10 unfilled with the electrode material mixture 20.

The tab convergence portion 12 has slanting portions 122 each slanting such that a thickness thereof decreases in a direction from the material mixture-filled segment 11 to the current-collecting tabs 13, and a rib-formed portion 124 where a rib 121 is formed.

In the rib-formed portion 124 of the tab convergence portion 12, at least one protruding rib 121 extends from a side adjacent to the material mixture-filled segment 11 toward the current-collecting tabs 13. In the present embodiment, the tab convergence portion 12 is provided with two ribs 121 formed therein. Specifically, as illustrated in FIG. 2, the ribs 121 reside in the tab convergence portion 12 and each form part of an associated one of two surfaces of the current collector 10 that are opposite in a thickness direction. As illustrated in FIG. 1, the ribs 121 are formed in an intermediate portion of the current collector 10 in a width direction.

The current-collecting tabs 13 are to be electrically connected to a lead tab (not illustrated) by welding. In the present embodiment, two current-collecting tabs 13 are formed and constitute the other end of the current collector 10. The two current-collecting tabs 13 are spaced apart from each other in the width direction of the current collector 10. Specifically, each current-collecting tab 13 extends from a portion of the tab convergence portion 12 where the rib 121 is absent, in a longitudinal direction of the current collector 10. The current-collecting tab 13 is thinner than the material mixture-filled segment 11. The porous metal material forming the current-collecting tabs 13 is denser than the porous metal material forming the material mixture-filled segment 11 and the tab convergence portion 12.

Each current-collecting tab 13 is provided with a stress alleviation portion 131 constituted by ridges and grooves in a width direction of the current-collecting tab 13. As illustrated in FIG. 2, the stress alleviation portion 131 is formed on two surfaces of each current-collecting tab 13, the surfaces being opposite in the thickness direction of the current collector 10. The ridges and grooves of the stress alleviation portion 131 preferably have a rectangular or square wave shape, a sine wave shape, a triangular wave shape, or a sawtooth shape, as viewed in cross section. As illustrated in FIG. 2, the ridges and grooves of the stress alleviation portion 131 of the present embodiment have a sine wave shape as viewed in cross section.

<Method of Producing Secondary Battery Electrode 1>

Next, an example of a method of producing the secondary battery electrode 1 according to the present embodiment will be described. First, pores of a current collector 10 are filled with an electrode material mixture 20 such that the current collector 10 has a region filled with the electrode material mixture 20 and a region not filled with the electrode material mixture 20. The current collector 10 is then subjected to rolling so that the region filled with the electrode material mixture 20 comes to form a material mixture-filled segment 11 filled with the electrode material mixture 20 at an increased filling density. The segment not filled with the electrode material mixture 20 is formed into a material mixture-unfilled segment 14 that includes a tab convergence portion 12 having slating portions 122 and a rib-formed portion 124, and that includes current-collecting tabs 13. A rib 121 may be formed in the rib-formed portion 124 by any process. From the viewpoint of efficiency, it is preferable to form the rib 121 by way of pressing the porous metal material. Specifically, in the tab convergence portion 12, a portion to be formed into the rib 121 is pressed with a lower pressure than a pressure applied to the other portions, thereby forming slanting portions 122 defined by the surfaces opposite in the thickness direction of the current collector 10 and the ribs 121 protruding further in the thickness direction of the current collector 10 relative to the slanting portions 122. The current-collecting tabs 13 constituting an end of the current collector 10 are more distant than the tab convergence portion 12 from the region filled with the electrode material mixture 20. Therefore, the current-collecting tabs 13 are easy to spread. Consequently, the porous metal material forming the current-collecting tabs 13 have a higher density than the porous metal material forming the tab convergence portion 12, and the current-collecting tabs 13 are made thin.

The secondary battery electrode 1 of the present embodiment exerts the following effects. The secondary battery electrode 1 of the present embodiment includes: the current collector 10 made of a porous metal material; and the electrode material mixture 20 with which the current collector 10 is filled. The current collector 10 includes the material mixture-filled segment 11 that is filled with the electrode material mixture 20 and the material mixture-unfilled segment 14 that is not filled with the electrode material mixture 20. The material mixture-unfilled segment 14 includes the current-collecting tabs 13 which are thinner than the material mixture-filled segment 11 and in which the porous metal material is present at a higher density than in the material mixture-filled segment 11, and the tab convergence portion 12 via which the material mixture-filled segment 11 is coupled to the current-collecting tabs 13. The tab convergence portion 12 is provided with at least one rib 121 extending from a side adjacent to the material mixture-filled segment 11 toward the current-collecting tabs 13. Thus, in the tab convergence portion 12, the rib 121 extends in the direction in which the current-collecting tabs 13 extend, thereby making it possible to increase a strength of the tab convergence portion 12. As a result, even without rounding a boundary between the material mixture-filled segment 11 and the tab convergence portion 12 and a boundary between the tab convergence portion 12 and the current-collecting tabs 13, a strength to cope with a stress applied to the boundaries can be increased. For example, in a case where two or more secondary battery electrodes 1 are stacked together and their current-collecting tabs 13 are put together to be welded to a lead tab, the increased strength can inhibit cracks and rupture that are likely to occur in the electrodes 1 due to the stress applied to the boundaries. Thus, the secondary battery electrode 1 that has both a satisfactory durability and a high energy density can be achieved. Further, during a production process including pressing the secondary battery electrode 1, the increased strength can inhibit cracks and rupture that are likely to occur in the secondary battery electrode 1 due to the stress applied when the end portion of the current collector 10 is subjected to rolling for the formation of the current-collecting tabs 13.

The rib 121 of the secondary battery electrode 1 of the present embodiment is formed by way of pressing the porous metal material. Thus, the rib 121 can be efficiently formed in the production process of the secondary battery electrode 1 simply by partially adjusting a strength of pressing onto the material mixture-unfilled segment 14.

The current-collecting tab 13 of the present embodiment has the stress alleviation portion 131 constituted by ridges and grooves that are formed on the current-collecting tab 13, and extend in the width direction of the current-collecting tab 13. The ridges and grooves have a rectangular or square wave shape, a sine wave shape, a triangular wave shape, or a sawtooth shape, as viewed in cross section. Due to this configuration, even if a stress is applied to the current-collecting tab 13 in the thickness direction of the current-collecting tab 13, the stress alleviation portion 131 allows the current-collecting tab 13 to deform in response to the stress. While the rib 121 increases the strength of the tab convergence portion 12, a stress applied to the tab convergence portion 12 can be released through the current-collecting tab 13. As a result, the durability of the secondary battery electrode 1 can be further improved.

### Second Embodiment

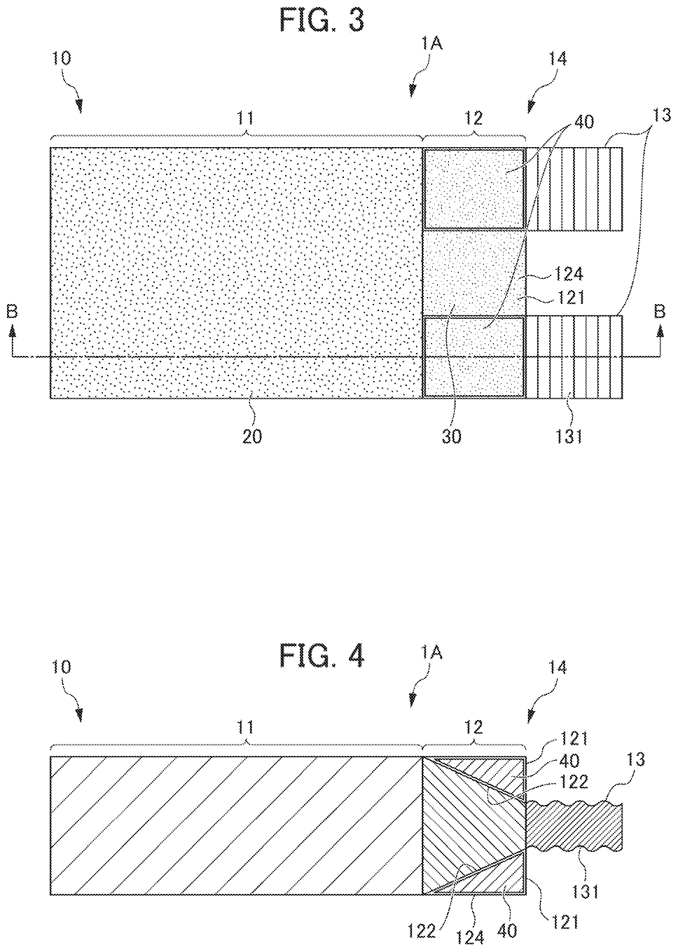

A secondary battery electrode 1A according to a second embodiment will be described with reference to FIGS. 3 and 4. FIG. 3 is a planar view illustrating the secondary battery electrode 1A. FIG. 4 is a cross-sectional view of the secondary battery electrode 1A, taken along line B-B in FIG. 3. Note that an electrode material mixture 20 included in the secondary battery electrode 1A is not illustrated in FIG. 4. In the following, the same components as those of the embodiment described above are denoted by the same reference characters, and a description thereof will be omitted.

As illustrated in FIG. 3, the secondary battery electrode 1A of the present embodiment includes a current collector 10 made of a porous metal material, an electrode material mixture 20 with which the current collector 10 is filled, a reinforcing material 30, and cushioning members 40. A main difference between the secondary battery electrode 1 of the first embodiment and the secondary battery electrode 1A lies in that the secondary battery electrode 1A includes the reinforcing material 30 and the cushioning members 40.

The reinforcing material 30 reinforces a tab convergence portion 12. The reinforcing material member 30 may be made of, for example, a resin. Examples of the resin applicable as the reinforcing member 30 include, but are not limited to: thermosetting resins such as a polyimide resin, an epoxy resin, a silicone resin, and a polyurethane resin; thermoplastic resins such as a polyolefin resin, a polystyrene resin, a fluorine resin, a polyvinyl chloride resin, a polymethacrylate resin, and a polyurethane resin; and photo-setting resins such as a silicone resin, a polymethacrylate resin, and a polyester resin. Among these examples, a polyethylene resin and polypropylene resin are preferred because they satisfy required electrical insulation against contact with a counter electrode, are inert to the electrode material mixture, are resistant to chemicals used in the production process of the electrode, have good processability, and have excellent heat resistance and excellent flexibility.

As illustrated in FIG. 3, the tab convergence portion 12 of the current collector 10 is filled with the reinforcing material 30. Specifically, the reinforcing material 30 is electrically insulating. The surface of the tab convergence portion 12 that includes a rib 121 and forms part of the current collector 10 is covered with the reinforcing material 30 with which the tab convergence portion 12 is filled. Thus, since the surface of the porous metal material is covered with the electrically-insulating reinforcing material 30 without being exposed, a short circuit of the secondary battery electrode 1A can be prevented.

A thermally conductive resin may be used as the reinforcing material 30. In the case of using the reinforcing material 30 having a thermal conductivity, heat generated in a material mixture-filled segment 11 can be dissipated through the tab convergence portion 12 and current-collecting tabs 13. Thus, even if two or more secondary battery electrodes 1A are stacked on each other to be formed into a thick layer, a temperature distribution is unlikely to become non-uniform, thereby enabling prevention of deterioration of the secondary battery electrode 1A.

In the tab convergence portion 12, the rib 121 and the slanting portions 122 may be filled with the reinforcing material 30 of the same type or reinforcing materials 30 of different types.

The cushioning members 40 are disposed on the slanting portions 122 of the tab convergence portion 12. In the present embodiment, four cushioning members 40 are disposed. Specifically, two cushioning members 40 are disposed on each of the two opposite surfaces of the current collector 10 facing each other in the thickness direction, while the rib 121 is interposed between the two cushioning members 40. Provision of the cushioning members 40 on the slanting portions 122 makes the thickness of the current collector 10 substantially uniform over the material mixture-filled segment 11 and the tab convergence portion 12.

It is preferable to use an electrically-insulating and/or thermally-conductive material as the cushioning member 40. In the present embodiment, an electrically-insulating resin is used as the cushioning members 40.

Here, when a battery is produced by stacking and putting two or more secondary battery electrodes 1A together, gaps are formed between the adjacent secondary battery electrodes 1A and between the slanting portion 122 and an electrolyte layer or the like, and such a gap between the tab convergence portions 12 is likely to receive a stress. Especially, in the case of an all solid state battery, since a restraining load is important, the gaps tend to receive a further stronger stress.

According to the present embodiment, the cushioning members 40 disposed on the slanting portions 122 can fill the gaps between the adjacent secondary battery electrodes 1A and the gaps between the slanting portions 122 of the tab convergence portion 12 and the electrolyte layer or the like. This configuration makes it possible to reduce a stress acting in the stacking direction onto the tab convergence portions 12 of the secondary battery electrodes 1A forming the battery. As a result, a battery including the secondary battery electrodes 1A can have an improved durability.

<Method of Producing Secondary Battery Electrode 1A>

Next, an example of a method of producing the secondary battery electrode 1A according to the present embodiment will be described. First, according to the above-described method of producing the secondary battery electrode 1, a current collector 10 is produced which includes a material mixture-filled segment 11 and a material mixture-unfilled segment 14 having a tab convergence portion 12 and current-collecting tabs 13. The tab convergence portion 12 is then filled with a reinforcing material 30. Further, cushioning members 40 are disposed on slanting portions 122 of the tab convergence portion 12.

The secondary battery electrode 1A of the present embodiment exerts the following effects. In the secondary battery electrode 1A of the present embodiment, the tab convergence portion 12 is filled with the reinforcing material 30 made of a resin. Due to this feature, in the tab convergence portion 12, the pores of the current collector 10 can be filled with the reinforcing material 30 instead of the electrode material mixture 20, whereby the tab convergence portion 12, which forms part of the current collector 10 and the strength of which is increased by the ribs 121, can be further reinforced.

In the foregoing, embodiments of the present disclosure have been described. It should be noted that the above-described embodiments are not intended to limit the scope of the present disclosure.

In the above embodiments, the tab convergence portion 12 has two ribs 121. However, the number of the ribs 121 formed in the tab convergence portion 12 are not limited to any particular number. For example, the tab convergence portion 12 may have only one rib 121 or three or more ribs 121.

In the above embodiments, the secondary battery electrode 1, 1A includes two current-collecting tabs 13. However, the number of the current-collecting tabs 13 is not limited to any particular number. For example, the secondary battery electrode 1, 1A may include only one current-collecting tab 13 or three or more current-collecting tabs 13.

In the second embodiment, the cushioning members 40 are disposed only on the slanting portions 122 of the tab convergence portion 12. However, the cushioning members 40 may be disposed not only on the slanting portions 122, but also on the rib-formed portion 124. In other words, the cushioning members 40 may be disposed on the two surfaces of the slanting portions 122 and those of the rib-formed portion 124, the surfaces being opposite in the thickness direction of the current collector 10.

### EXPLANATION OF REFERENCE NUMERALS

1, 1A: Secondary Battery Electrode
10: Current Collector
11: Material Mixture-Filled Segment
12: Tab Convergence Portion
13: Current-Collecting Tab
14: Material Mixture-Unfilled Segment
20: Electrode Material Mixture
121: Rib

What is claimed is:

1. A secondary battery electrode comprising:
a current collector made of a porous metal material; and
an electrode material mixture with which the current collector is filled,
wherein the current collector includes
a material mixture-filled segment that is filled with the electrode material mixture, and
a material mixture-unfilled segment that is unfilled with the electrode material mixture,
wherein the material mixture-unfilled segment includes
a current-collecting tab which is thinner than the material mixture-filled segment and in which the porous metal material is present at a higher density than in the material mixture-filled segment, and
a tab convergence portion via which the material mixture-filled segment is coupled to the current-collecting tab, and
wherein the tab convergence portion is provided with at least one rib extending from a side adjacent to the material mixture-filled segment toward the current-collecting tab.

2. The secondary battery electrode according to claim 1,
wherein the at least one rib is formed by way of pressing the porous metal material.

3. The secondary battery electrode according to claim 1,
wherein the current-collecting tab has a stress alleviation portion constituted by ridges and grooves that extend in a width direction of the current-collecting tab, and
wherein the ridges and grooves have a rectangular or square wave shape, a sine wave shape, a triangular wave shape, or a sawtooth shape, as viewed in cross section.

4. The secondary battery electrode according to claim 1,
wherein the tab convergence portion is filled with a reinforcing material that reinforces the tab convergence portion.

5. The secondary battery electrode according to claim 4, wherein the tab convergence portion is covered with the reinforcing material with which the tab convergence portion is filled.

6. The secondary battery electrode according to claim 4, wherein the reinforcing material is electrically insulating.

7. The secondary battery electrode according to claim 4, wherein the reinforcing material is thermally conductive.

8. The secondary battery electrode according to claim 1,
wherein the tab convergence portion has
a rib-formed portion where the at least one rib is formed, and
a slanting portion which slants such that a thickness thereof decreases in a direction from the material mixture-filled segment to the current-collecting tab, and
wherein the tab convergence portion is provided with cushioning members disposed at least on surfaces of the slanting portion, the surfaces being opposite in a thickness direction of the slanting portion.
